(19) United States
(12) Patent Application Publication
(10) Pub. No.: US 2019/0346975 A1
(43) Pub. Date: Nov. 14, 2019

(54) SYSTEMS AND METHODS FOR IMPROVED EMAIL ATTACHMENT VIEWING

(71) Applicant: Citrix Systems, Inc., Fort Lauderdale, FL (US)

(72) Inventor: Ankita Chandak, Fort Lauderdale, FL (US)

(21) Appl. No.: 15/976,520

(22) Filed: May 10, 2018

(51) Int. Cl. G06F 3/0482; H04L 12/58; G06F 3/0481; G06F 3/0484

(52) U.S. Cl. CPC G06F 3/0482; H04L 51/08; G06F 3/0484; G06F 3/0481; G06F 3/04817

(57) ABSTRACT

Systems and methods for improved email attachment viewing. The methods comprise: displaying a first window or view comprising a list of electronic mail messages on a display screen of a computing device; presenting a selectable attachment widget in the first window or view so as to be associated with each of the electronic mail messages that has one or more attachments provided therewith; receiving a first user-software interaction for selecting the selectable attachment widget associated with one of the electronic mail messages including content of a given conversation of a plurality of conversations to which the user of the computing device is a participant; generating a list of attachments that are associated with the given conversation, in response to the first user-software interaction; and presenting the list of attachments in a second window or view on the display screen of the computing device.

### BACKGROUND

### Statement of the Technical Field

The present disclosure relates generally to computing systems. More particularly, the present disclosure relates to implementing systems and methods for improved email attachment viewing.

### Description of the Related Art

Remote desktops are often used by business entities to allow employees access to various software applications, such as an electronic mail application. Conventional electronic mail applications typically require a user to scroll through an entire email history in order to find an attachment of interest or to scroll through a list of all attachments in an inbox to find a conversation of interest and an attachment of interest. These are time consuming and inefficient processes.

### SUMMARY

The present disclosure concerns implementing systems and methods for improved email attachment viewing. The methods comprise: displaying a first window or view comprising a list of electronic mail messages on a display screen of a computing device; presenting a selectable attachment widget in the first window or view so as to be associated with each of the electronic mail messages that has one or more attachments provided therewith; receiving, by the computing device, a first user-software interaction for selecting the selectable attachment widget associated with one of the electronic mail messages including content of a given conversation of a plurality of conversations to which the user of the computing device is a participant; generating a list of attachments that are associated with the given conversation, in response to the first user-software interaction; and presenting the list of attachments in a second window or view on the display screen of the computing device.

The computing device also receives a second user-software interaction for selecting a specific attachment contained in the list. The specific attachment is opened in response to the second user-software interaction. The specific attachment is closed in response to the computing device's reception of a third user-software interaction. The attachments can be ordered in the list based on their dates of reception (e.g., most recent attachment first or last) or at least one source characteristic. The second window or view can be displayed on top of the first window or view, replaces the first window or view on the display screen, or is displayed adjacent to the first window or view on the display screen.

In some scenarios, the selectable attachment widget comprises an icon. The selectable attachment widget may comprise a selectable attachment icon or be provided in addition to a non-selectable attachment icon within the first window or view.

### BRIEF DESCRIPTION OF THE DRAWINGS

The present solution will be described with reference to the following drawing figures, in which like numerals represent like items throughout the figures.

FIG. 1 is an illustration of an illustrative system.

FIG. 2 is an illustration of an illustrative architecture for a computing device.

FIG. 3 is a flow diagram of an illustrative method for improved email attachment viewing.

FIG. 4 is an illustration of a first window or view for an electronic mail software application.

FIG. 5 is an illustration showing a mouse click on an attachment widget (e.g., icon).

FIG. 6 is an illustration showing a window or view displayed in response to a mouse click on an attachment widget in which attachments are ordered by date (e.g., in reverse order, most recent first).

FIG. 7 is an illustration showing a window or view displayed in response to a mouse click on an attachment widget in which attachments are ordered by source.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present document provides a solution for determining how to keep track of all attachments per mail conversation in a single view. In accordance with the present solution, attachments per conversation are more easily available to users as compared to their availability when using conventional solutions. The present solution solves the problem of finding the attachments in a given mail conversation without employing a collective scrolling feature as has been done in the past, i.e., a user no longer needs to scroll through the entire email history in order to find an attachment of interest or to scroll through a list of all attachments in an inbox to find a conversation of interest and the attachment of interest. Therefore, the attachment of interest can be found quicker and more easily with the present solution. Also, the present solution saves the user the trouble of going back in time per mail conversation to find attachments of interest. The user is able to just click on a selectable widget (e.g., icon) for the conversation, and be presented with a consolidated view of all attachments associated with the conversation.

Illustrative System Architecture

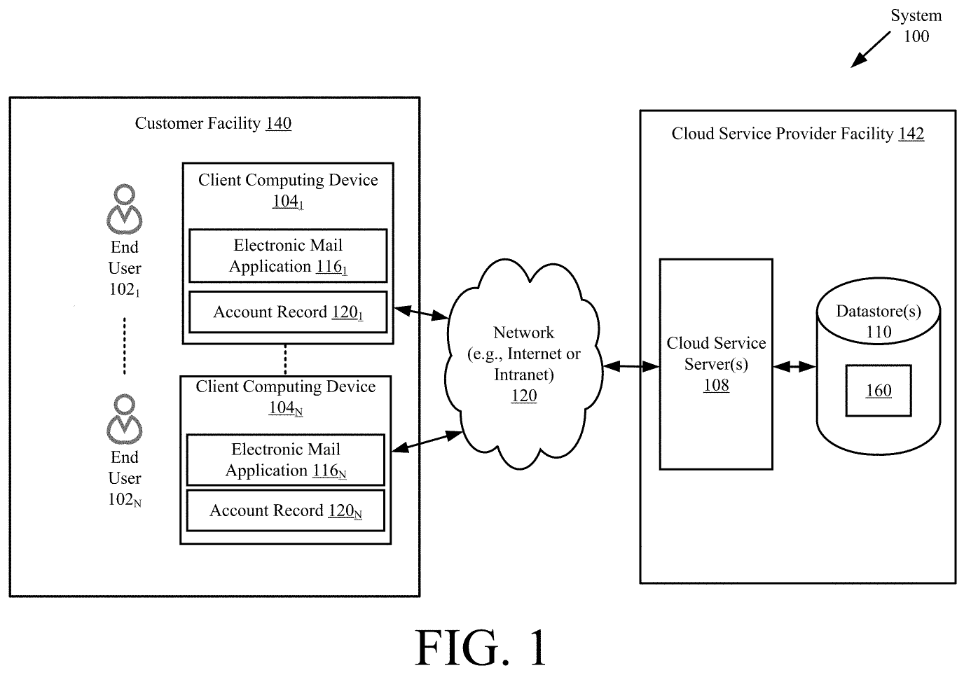

Referring now to FIG. 1, there is provided an illustration of an illustrative system 100. System 100 implements methods for improved email attachment viewing. In this regard, system 100 comprises a customer facility 140 and a cloud service provider facility 142. The customer facility 140 comprises one or more buildings of a customer, such as a business organization (e.g., a hospital). The customer has one or more end users 102₁, . . . , 102_{N}. The end users can include, but is not limited to, employees. Each end user uses a client computing devices 104₁-104_{N} (e.g., thin clients) for a variety of purposes, such as accessing and using cloud services provided by a cloud service provider. In this regard, the client computing devices 104i-104_{N} are configured to facilitate access to applications and virtual desktops without interruptions resulting from connectivity loss. Accordingly, the client computing devices 104₁-104_{N} have installed thereon and execute various software applications. These software applications include, but are not limited to, electronic mail applications 116₁, . . . , 116_{N} and/or web browsers (not shown). Electronic mail applications and web browsers are well known in the art, and therefore will not be described herein. Any known or to be known electronic mail applications and web browser can be used herein without limitation provided that it can be modified to implement the present solution. For example, the electronic mail application may include, but is not limited to, Microsoft Outlook or Gmail modified to implement the present solution.

The client computing devices 104₁-104_{N} also have various information stored internally. This information includes, but is not limited to, account records 120₁-120_{N}. The client computing devices 104₁-104_{N} are able to communicate with each other via an Intranet and with external devices via the Internet. The Intranet and Internet are shown in FIG. 1 as a network 120.

The external devices include one or more cloud service servers 108 located at the cloud service provider facility 142. The cloud service provider facility 142 comprises one or more buildings of a cloud service provider. The server(s) 108 is(are) configured to facilitate access to applications and virtual desktops without interruptions resulting from connectivity loss. Accordingly, the server 108 has installed thereon and executes various software applications. The software applications include, but are not limited to, a StoreFront and a Desktop Delivery Controller (“DDC”). StoreFronts and DDCs are well known in the art, and therefore will not be described herein. Any known or to be known StoreFront and/or DDC can be employed herein.

The server 108 is also configured to access the datastore 110 in which publishing information 160 is stored, and is also able to write/read from the datastore(s) 110. The publishing information 160 includes, but is not limited to, software applications, code, media content (e.g., text, images, videos, etc.), and/or user authentication information (e.g., a user name and/or facial feature information).

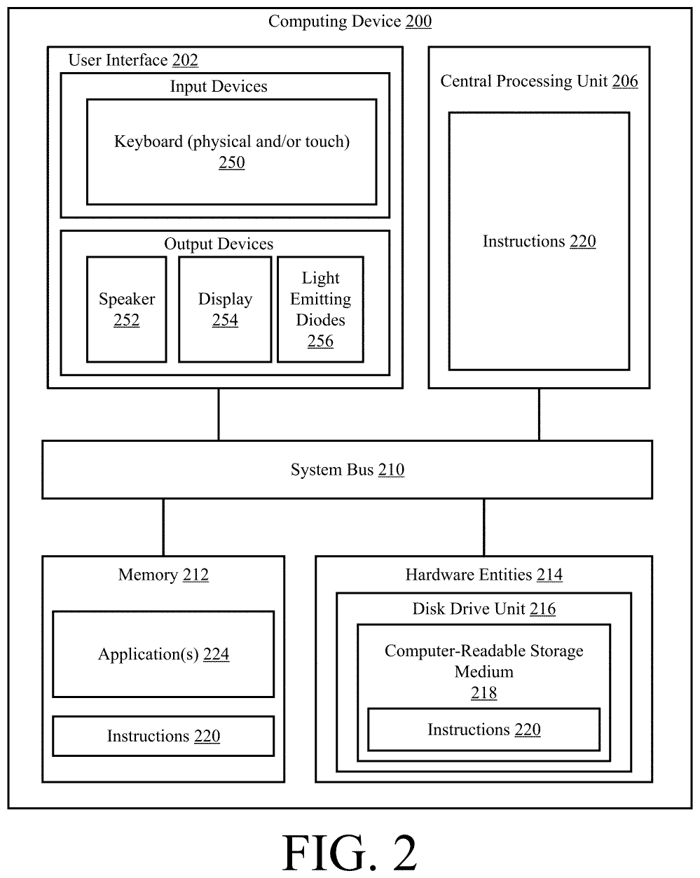

Referring now to FIG. 2, there is provided an illustration of an illustrative architecture for a computing device 200. Computing devices 104₁-104_{N} and/or server(s) 108 of FIG. 1 (is)are the same as or similar to computing device 200. As such, the discussion of computing device 200 is sufficient for understanding these components of system 100.

In some scenarios, the present solution is used in a client-server architecture. Accordingly, the computing device architecture shown in FIG. 2 is sufficient for understanding the particulars of client computing devices and servers.

Computing device 200 may include more or less components than those shown in FIG. 2. However, the components shown are sufficient to disclose an illustrative solution implementing the present solution. The hardware architecture of FIG. 2 represents one implementation of a representative computing device configured to provide improved email attachment viewing, as described herein. As such, the computing device 200 of FIG. 2 implements at least a portion of the method(s) described herein.

Some or all components of the computing device 200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (“CPU”) 206, a system bus 210, a memory 212 connected to and accessible by other portions of computing device 200 through system bus 210, and hardware entities 214 connected to system bus 210. The user interface can include input devices and output devices, which facilitate user-software interactions for controlling operations of the computing device 200. The input devices include, but are not limited, a physical and/or touch keyboard 250. The input devices can be connected to the computing device 200 via a wired or wireless connection (e.g., a Bluetooth® connection). The output devices include, but are not limited to, a speaker 252, a display 254, and/or light emitting diodes 256.

At least some of the hardware entities 214 perform actions involving access to and use of memory 212, which can be a Random Access Memory (“RAM”), a disk driver and/or a Compact Disc Read Only Memory (“CD-ROM”). Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 220 for execution by the computing device 200 and that cause the computing device 200 to perform any one or more of the methodologies of the present disclosure.

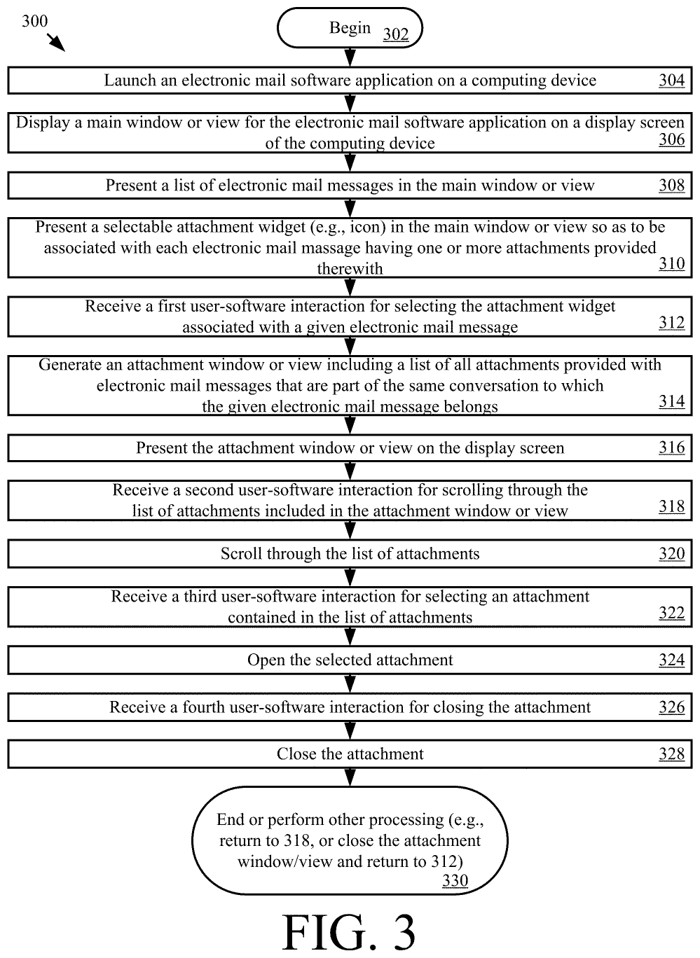

Referring now to FIG. 3, there is provided a flow diagram of an illustrative method 300 for improved email attachment viewing. Method 300 begins with 302 and continues with 304 where an electronic mail software application (e.g., application 224 of FIG. 2) is launched on a computing device (e.g., computing device 104₁, . . . , 104_{N} of FIG. 1 or 200 of FIG. 2). Next in 306, a first window or view for the electronic mail software application is displayed on a display screen (e.g., display 254 of FIG. 2) of the computing device. A list of electronic mail messages are presented in the first window or view, as shown by 308. A selectable attachment widget is also presented in the first window or view, as shown by 310. The selectable attachment widget is presented so as to be associated with each electronic mail message having one or more attachments provided therewith.

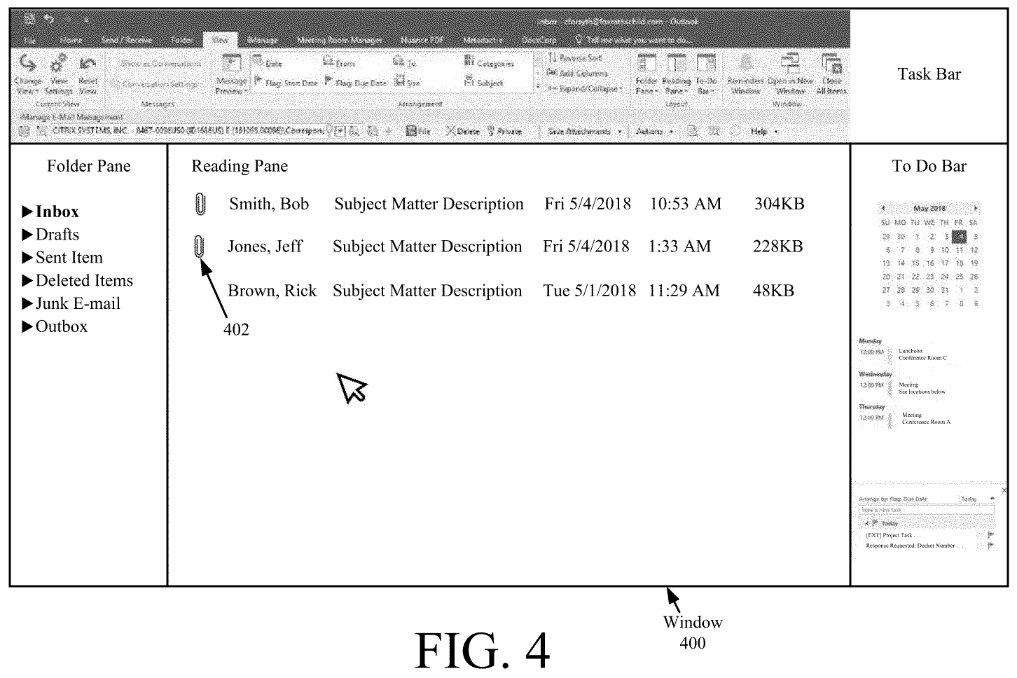

An illustration of an illustrative first window 400 is provided in FIG. 4. As shown in FIG. 4, the selectable attachment widget 402 comprises an attachment icon. The present solution is not limited in this regard. The attachment widget can include any widget that allows selection thereof for initiating an operation (e.g., list generation). For example, the attachment widget can alternatively comprises a virtual button. Also, the attachment widget can be provided in addition to the conventional non-selectable attachment icons within a window or view.

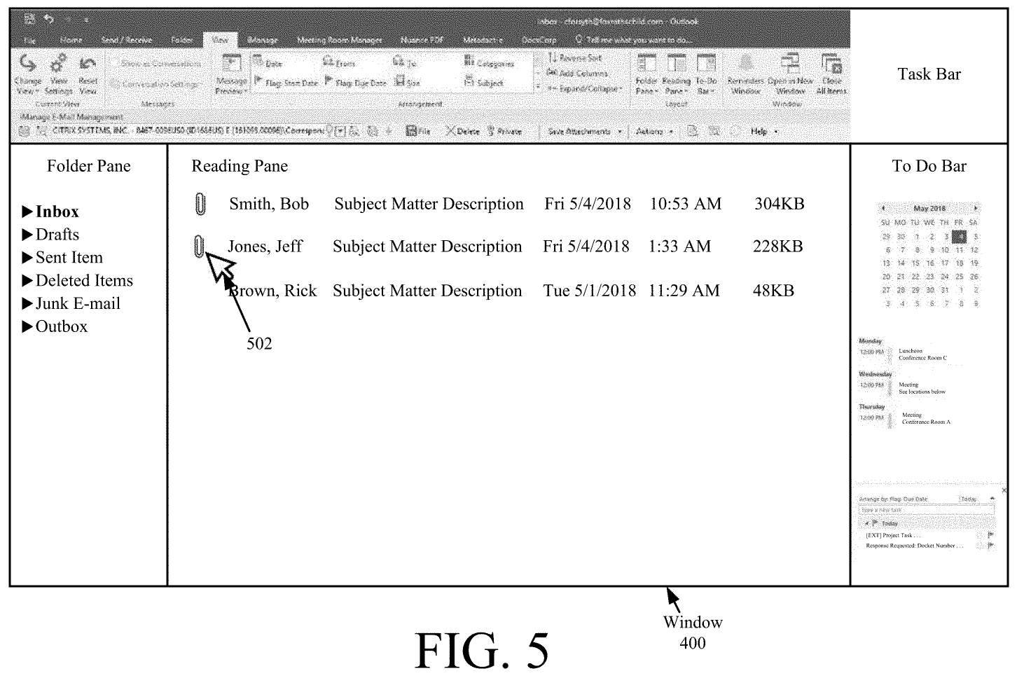

Referring again to FIG. 3, method 300 continues with 312 where a first-user software interaction is received by the computing device. The first user-software interaction is for selecting the attachment widget associated with a given electronic mail message. The first user-software interaction can be achieved by: moving a mouse cursor (e.g., mouse cursor 502 of FIG. 5) over the attachment widget; and clicking a left mouse button to select the attachment widget. The present solution is not limited in this regard. Other techniques for selecting a widget can be used herein. For example, the arrow keys and an enter key on a keyboard can be used.

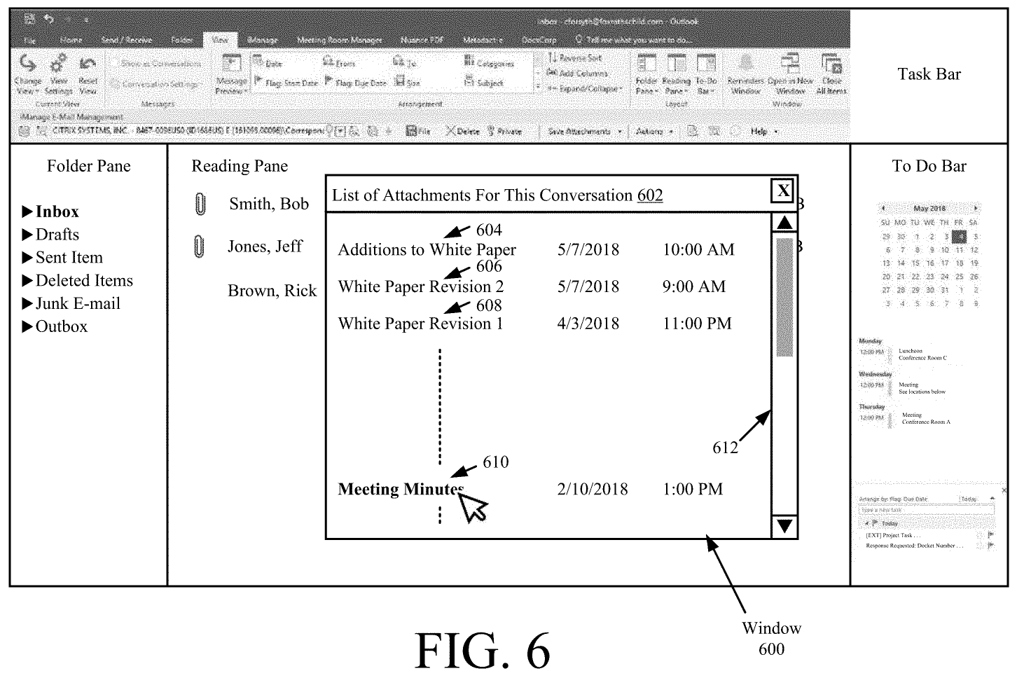

In response to the first user-software interaction, the computing device generates a second window or view as shown by 314. The second window or view includes a list (e.g., list 602 of FIG. 6) of all attachments (e.g., attachments 604, 606, 608, . . . , 610 of FIG. 6) provided with electronic mail messages that are part of the same conversation to which the given electronic mail message belongs. The second window or view is then presented on the display screen in 316.

An illustration showing a second window or view displayed on a display screen is provided in FIG. 6. As shown in FIG. 6, the second window or view 600 is displayed on top of the first window 400. The present solution is not limited in this regard. In some scenarios (e.g., smart phone scenarios), the second view replaces the first view on the display screen. Also, in other scenarios, the display can be modified such that the first window or view is shown on a first part (e.g., left side or top) of the screen and the second window or view is shown on a second part (e.g., the right side or bottom) of the screen. Stated differently, the first and second windows or view can be displayed adjacent to each other on the display screen.

In next 318, a second user-software interaction is received by the computing device. The second user-software interaction is for scrolling through the list of attachments included in the second window or view. The second user-software interaction is facilitated by a scroll bar (e.g., scroll bar 612 of FIG. 6). In response to the second user-software interaction, the computing device scrolls through the list of attachments, as shown by 320. Notably, this scrolling operation of the present solution is different from the scrolling operation of conventional attachment viewing solutions. In this regard, it should be emphasized that the present scrolling operation of 318 allows a user to scroll through attachments that are associated with a single email conversation, rather than a plurality of email conversations as is done in the conventional attachment viewing solutions. Consequently, the present solution improves upon computer technology by making an email viewing process more efficient, less time consuming, and more user-friendly.

Next in 322, the computing device receives a third user-software interaction for selecting an attachment (e.g., attachment 610 of FIG. 6) contained in the list of attachments (e.g., list 602 of FIG. 6). The selected attachment is then opened in response to the third user-software interaction, as shown by 324. Thereafter, a fourth user-software interaction is received by the computing device in 326. Responsive to the fourth user-software interaction, the attachment is closed in 328. Subsequently, 330 is performed where method 300 ends or other processing is performed. The other processing can involve returning to 318. Alternatively, the other processing can involve closing the attachment window or view, and returning to 312.

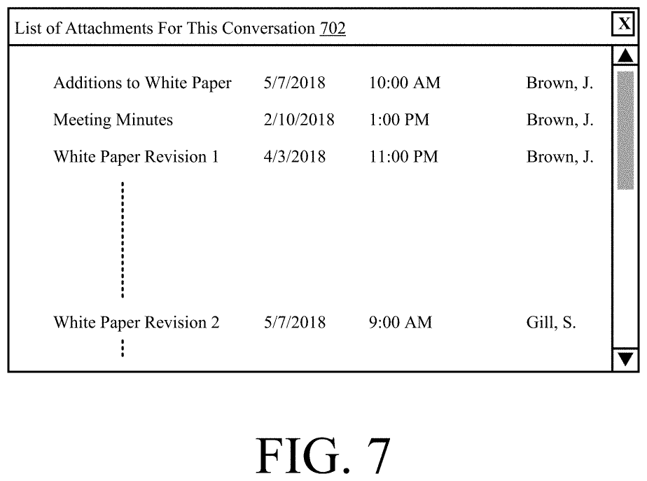

Notably, the attachments in the list can be ordered in accordance with any given application. For example, in some scenarios, the attachments are (by default) ordered in accordance with their date of reception (e.g., as shown in FIG. 6) starting from the most recently received attachment. In other scenarios, the manner in which the list is ordered is user configurable. For example, a user can cause the attachments to be grouped by source and then presented in an order based on source characteristics (e.g., employee title, status, location, department, and/or relationships to each other), as shown in FIG. 7.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for improved email attachment viewing, comprising:
displaying a first window or view comprising a list of electronic mail messages on a display screen of a computing device;
presenting a selectable attachment widget in the first window or view so as to be associated with each of the electronic mail messages that has one or more attachments provided therewith;
receiving, by the computing device, a first user-software interaction for selecting the selectable attachment widget associated with one of the electronic mail messages including content of a given conversation of a plurality of conversations to which the user of the computing device is a participant;
generating a list of attachments that are associated with the given conversation, in response to the first user-software interaction; and
presenting the list of attachments in a second window or view on the display screen of the computing device.

2. The method according to claim 1, wherein the selectable attachment widget comprises an attachment icon.

3. The method according to claim 1, wherein the selectable attachment widget is provided in addition to a non-selectable attachment icon within the first window or view.

4. The method according to claim 1, wherein the second window or view is displayed on top of the first window or view.

5. The method according to claim 1, wherein the second window or view replaces the first window or view on the display screen.

6. The method according to claim 1, wherein the second window or view is displayed adjacent to the first window or view on the display screen.

7. The method according to claim 1, further comprising receiving, by the computing device, a second user-software interaction for selecting a specific attachment contained in the list.

8. The method according to claim 7, further comprising opening the specific attachment in response to the second user-software interaction.

9. The method according to claim 8, further comprising closing the specific attachment in response to the computing device's reception of a third user-software interaction.

10. The method according to claim 1, where in the attachments are ordered in the list based on dates of reception or at least one source characteristic.

11. A system, comprising:
a processor; and
a non-transitory computer-readable storage medium comprising programming instructions that are configured to cause the processor to implement a method for improved email attachment viewing, wherein the programming instructions comprise instructions to:
cause a first window or view comprising a list of electronic mail messages to be displayed on a display screen;
cause a selectable attachment widget to be included in the first window or view so as to be associated with each of the electronic mail messages that has one or more attachments provided therewith;
receive a first user-software interaction for selecting the selectable attachment widget associated with one of the electronic mail messages including content of a given conversation of a plurality of conversations to which the user of the computing device is a participant;
generate a list of attachments that are associated with the given conversation, in response to the first user-software interaction; and
present the list of attachments in a second window or view on the display screen of the computing device.

12. The system according to claim 11, wherein the selectable attachment widget comprises an attachment icon.

13. The system according to claim 11, wherein the selectable attachment widget is provided in addition to a non-selectable attachment icon within the first window or view.

14. The system according to claim 11, wherein the second window or view is displayed on top of the first window or view.

15. The system according to claim 11, wherein the second window or view replaces the first window or view on the display screen.

16. The system according to claim 11, wherein the second window or view is displayed adjacent to the first window or view on the display screen.

17. The system according to claim 11, wherein the programming instructions further comprise instructions to receive a second user-software interaction for selecting a specific attachment contained in the list.

18. The system according to claim 17, wherein the programming instructions further comprise instructions to open the specific attachment in response to the second user-software interaction.

19. The system according to claim 18, wherein the programming instructions further comprise instructions to close the specific attachment in response to the computing device's reception of a third user-software interaction.

20. The system according to claim 11, wherein the attachments are ordered in the list based on dates of reception or at least one source characteristic.
